(19) United States
(12) Patent Application Publication
(10) Pub. No.: US 2019/0164187 A1
(43) Pub. Date: May 30, 2019

(54) IMAGE PROCESSING TO DETECT AGING PRODUCE

(71) Applicant: NCR Corporation, Duluth, GA (US)

(72) Inventor: Christopher John Costello, Suwanee, GA (US)

(21) Appl. No.: 15/822,624

(22) Filed: Nov. 27, 2017

(51) Int. Cl. G06Q 30/02; G06Q 20/20; G06K 9/62; G06K 9/46

(52) U.S. Cl. CPC G06Q 30/0238; G06Q 20/208; G06K 2209/17; G06K 9/6215; G06K 9/4652; G06Q 30/0237

(57) ABSTRACT

During a transaction at a Point-Of-Sale (POS) terminal an image of produce placed in the field of view of a scanner or camera. The image is processed for characteristics associated with the produce and the characteristics are scored and compared against a threshold to determine whether the produce is to receive a discounted price during the transaction.

### BACKGROUND

Retailers experience significant financial loss due to aging perishables. In fact, loss from perishable produce exceeds loss due to theft by a margin of 2-3 to 1. The loss from throwing away produce can exceed 1 billion dollars by some large retailers.

Every day, produce retailers are forced to throw away perfectly edible produce due to its visual appearance and because customers are more apt to purchase fresher appearing produce when placed side-by-side with aging produce.

### SUMMARY

In various embodiments, methods and a system are presented for image processing to detect aging produce.

According to an embodiment, a method for image processing to detect aging produce is presented. Specifically, in an embodiment, an image for a produce item is received and features are extracted from the image. The features are scored to calculate a score and the score is compared against a threshold to calculate a difference. Next, a determination is made as to whether a discount is to be applied to a price of the produce based on the difference.

### BRIEF DESCRIPTION OF THE DRAWINGS

FIG. 1 is a diagram of a system 100 for image processing to detect aging produce, according to an example embodiment.

FIG. 2 is a diagram of a method for image processing to detect aging produce, according to an example embodiment.

FIG. 3 is a diagram of another method for image processing to detect aging produce, according to an example embodiment.

FIG. 4 is a diagram of a system for image processing to detect aging produce, according to an example embodiment.

### DETAILED DESCRIPTION

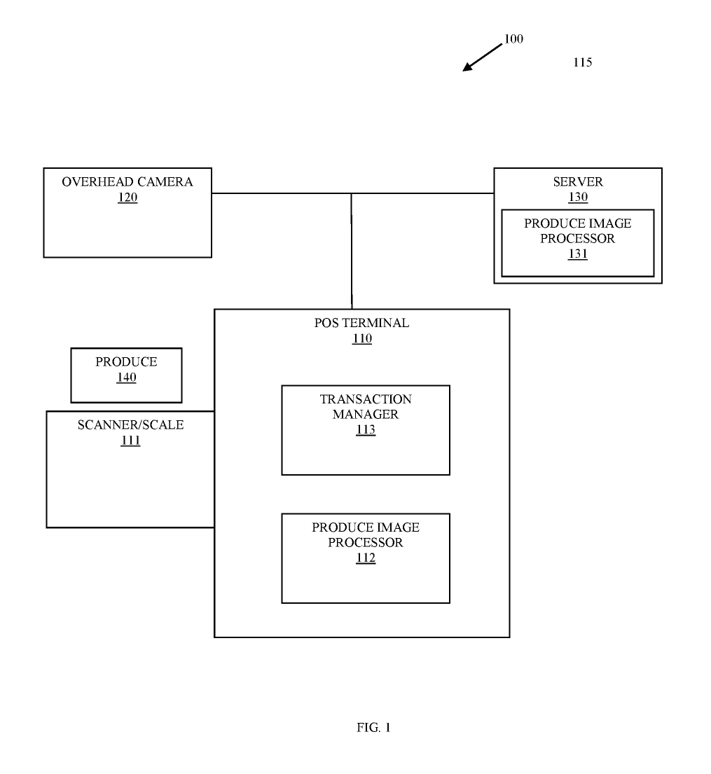

FIG. 1 is a diagram of a system 100 for image processing to detect aging produce, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of image processing to detect aging produce presented herein.

The system 100 includes device a Point-Of-Sale (POS) terminal 110 having a scanner/scale 111, a produce image processor 112, and a transaction manager 113. Optionally, the system includes an overhead camera 120 and a server 130. Also, optionally, the server may process the produce image processor 131.

The scanner/scale 111 can be just a scanner with an integrated camera or can be a combined scanner and scale with an integrated scanner.

The scanner/scale 111 captures images of produce 140 during a transaction at the POS terminal 110. The images are provided in real time during the transaction from the scanner/scale 111 to the produce image processor 112.

It is noted that although the description that follows describes the produce image processor 112 as processing on the POS terminal 110, this does not have to be the case. That is, in some embodiments, the images are sent from the POS terminal 110 over a network connection to the server 130 where image processor 131 processes the image and returns the results back to the POS terminal 110.

In an embodiment, the images of the produce 140 may optionally be captured during the transaction by an overhead camera 120 and sent over a connection to the produce image processor 112 of the POS terminal 111 or to the produce image processor 131 of the server 130.

In an embodiment, multiple images of the produce 140 at different angles are taken by the scanner/scale 111 and the overhead camera 120. The multiple images are processed by the image processor 112 or 131.

The type of produce 140 is supplied during the transaction by an operator of the POS terminal 110 as input received by the transaction manager 113. For example, the type of produce 140 may be bananas, tomatoes, peaches, lettuce, etc.

The transaction manager 113 provides the type of produce 140 to the image processor 112.

The image processor 112 receives the images from the scanner/scale 111 and the type of produce that corresponds to the produce 140 from the transaction manager.

Additionally, the image processor 112 may be configured with threshold values for each type of produce 140 at the start of each boot or startup of the POS terminal 110 from the server 130. Alternatively, the image processor 112 dynamically acquires the threshold values for the type of produce 140 when supplied the type of produce 140 from the transaction manager 113 during the transaction from the server 130.

The image processor 112 and extracts characteristics from the pixel values of the images. The characteristics may also be referred to herein as features. The characteristics identifier color values, texture (smoothness in transitions between the color values), light intensity, etc. The known quality (pixel density and/or resolution) of the scanner/scale 111 is preconfigured as attributes of the scanner/scale 111 within the image processor 112. Adjustments or weights to the characteristics are dynamically applied by the image processor 112 based on the known quality of the scanner/scale 111.

The image processor 112 then scores or calculates a score for the characteristics based on any adjustments for the quality of the scanner/scale 111.

The score of the produce image is then compared against the threshold value for the type of produce 140. When the score falls below the threshold, the image processor 112 sends a message to the transaction manager 112 indicating that the price for the produce 140 is to be discounted in price by a predefined amount. In an embodiment, the image processor 112 is further configured to include ranges of values that fall below the threshold, such that different levels of discounts on the produce 140 can be provided by the image processor 112 to the transaction manager 113 for discounting a price associated with the produce 140 at different levels of discount. That is, the difference between the score for the image of the produce 140 and the threshold value for that type of produce 140 is compared to the predefined ranges. Each range is linked and mapped to a specific level of discount for the produce 140.

The image processor 112 returns a “no change” in price message to the transaction manager 113 when the score for the image of the processor 140 is at or above the threshold value for that type of produce 140.

A variety of different image processing techniques can be used to extract the image characteristics/features from the images of the produce 140. Additionally, a variety of different scoring techniques can be used for scoring the image characteristics/features. In an embodiment, the extraction of the image characteristics by the image processor 112 on the image can be dependent upon the type of produce 140 for which the image is relevant to. That is, the image processor 112 may use a different feature extraction process for bananas from that which is used for tomatoes.

The image processor 112 selects a scoring technique for scoring the image of the produce 140 based on the type of produce 140. For example, for bananas detected brown spots may be counted to arrive at a score for the bananas and then compared against a threshold for bananas for the total number of counted brown spots. For tomatoes, wrinkling (smoothness) can be scored based on the number of detected wrinkles divided by an average length for the wrinkles, the threshold value for the tomato may be a value expected for a fresh tomato with an acceptable number of wrinkles divided by an acceptable average length for wrinkles. In fact, any customized scoring that is specific to the type of produce 140 can be processed by the image processor 112 based on a type of produce 140. The scoring technique corresponds with the threshold value for a freshness of a type of produce 140.

In an embodiment, when the transaction manager 113 receives a discounted price for the produce 140 from the image processor 112, the transaction manager 113 presents on a display of the POS terminal 110 an indication that the produce 140 is receiving the discounted price. This allows the customer (purchaser) to see the discount and may encourage the customer to continue to purchase produce that visually do not appear to be fresh.

Additionally, once the customer realizes that deformities in produce 140 will result in a discounted price at checkout, the customer will subsequently proactively seek to have produce deformities recognized by the scanner/scale 111, which means the customer will self-learn to present any deformity in the produce in direct field of view or line of sight of the scanner/scale 111; resulting in increased likelihood of the image processor 112 catching and discounting produce deformities in subsequent transactions with the customer.

In an embodiment, the feature extraction and scoring are processed to detect deformities in color for the produce 140 and deformities in texture (smoothness or degree of wrinkling) for the produce 140. The deformities directly correlate to aging and freshness of the produce 140.

In an embodiment, the POS terminal 110 is a Self-Service Terminal (SST) operated by a customer that is purchasing the produce 140.

In an embodiment, the POS terminal 110 is a cashier-assisted terminal operated by a cashier that is checking the customer out for the transaction.

The system 100 provides a mechanism by which varying degrees of produce aging can be detected and automatically apply a discounted price for the produce 140 during checkout at a POS terminal 110. Previous attempts by the industry have focused on applying barcodes on each item of produce 140, which is not practical and not commonly used for all produce items and which requires a significant manual effort that outweighs detecting non-fresh produce. The present system 100 can be dynamically processed with existing POS terminal 110 equipment during customer checkout. As a result, retailers will save a significant amount of money by dramatically reducing the amount of produce 140 that needs to be thrown away while obtaining revenue for the non-fresh produce.

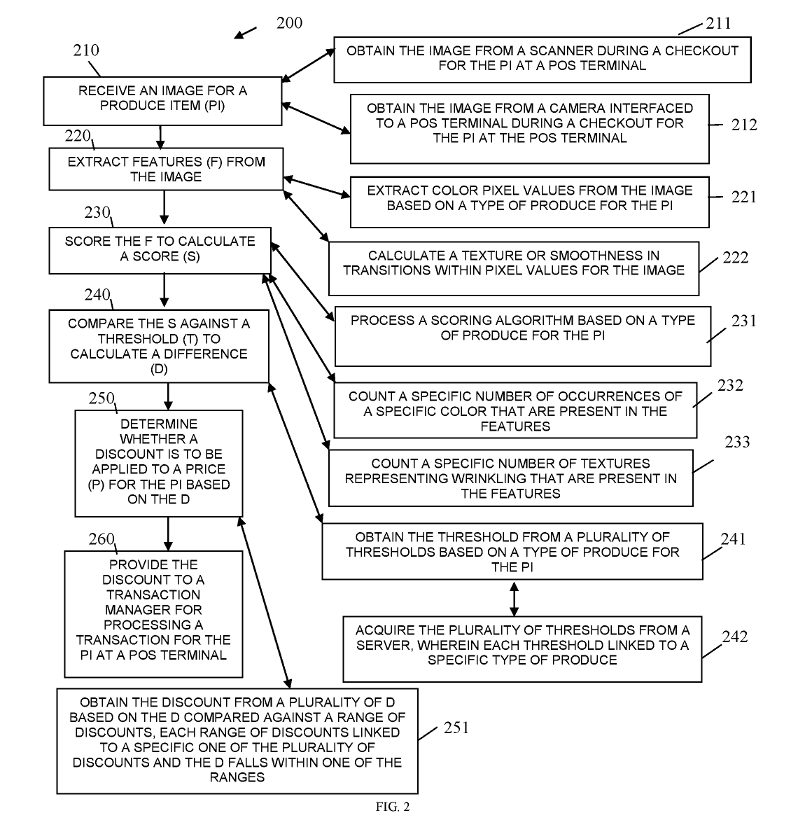

These and other embodiments are now discussed with reference to the FIGS. 2-4.

FIG. 2 is a diagram of a method 200 for image processing to detect aging produce, according to an example embodiment. The software module(s) that implements the method 200 is referred to as a “produce freshness manager.” The produce freshness manager is implemented as executable instructions programmed and residing within memory and/or a non-transitory computer-readable (processor-readable) storage medium and executed by one or more processors of a device. The processor(s) of the device that executes the produce freshness manager are specifically configured and programmed to process the produce freshness manager. The produce freshness manager has access to one or more network connections during its processing. The network connections can be wired, wireless, or a combination of wired and wireless.

In an embodiment, the produce freshness manager is the produce image processor 112 or the produce image processor 131.

In an embodiment, the device that executes the produce freshness manager is the POS terminal 110. In an embodiment, the POS terminal 110 is a SST. In an embodiment, the POS terminal is a cashier-assisted checkout terminal.

In an embodiment, the device that executes the produce freshness manager is the server 130.

At 210, the produce freshness manager receives an image for a produce item.

In an embodiment, at 211, the produce freshness manager obtains the image from a scanner during a checkout for the produce item at a POS terminal.

In an embodiment, at 212, the produce freshness manager obtains the image from a camera interfaced to a POS terminal during a checkout for the produce item at the POS terminal. In an embodiment, the camera is situated overhead for a birds eye view of the produce item placed on a counter of the POS terminal during checkout. In an embodiment, the camera is the camera 120.

At 220, the produce freshness manager extracts features from the image.

In an embodiment, at 221, the produce freshness manager extracts color pixel values from the image based on a type of produce for the produce item.

In an embodiment, at 222, the produce freshness manager calculates a texture or smoothness in transitions within pixels values for the image. This permits a determination of an amount of wilting or wrinkling in the produce item.

At 230, the produce freshness manager scores the features to calculate a score for the produce item.

In an embodiment, at 231, the produce freshness manager processes a scoring algorithm based on a type of produce for the produce item.

In an embodiment, at 232, the produce freshness manager counts a specific number of occurrences of a specific color that is present in the features. For example, count the number of brown spots present in a produce item that is bananas.

In an embodiment, at 233, the produce freshness manager counts a specific number of textures representing wrinkling or wilting that are present in the features. For example, wrinkles and wrinkle length for a produce time that is a tomato or a peach.

At 240, the produce freshness manager compares the score against a threshold value to calculate a difference.

In an embodiment, at 241, the produce freshness manager obtains the threshold value from a plurality of threshold values based on the type of produce for the produce item.

In an embodiment of 241 and at 242, the produce freshness manager acquires a plurality of thresholds (threshold values) from a sever. Each threshold value (each threshold) linked or mapped to a specific type of produce.

At 250, the produce freshness manager determines whether a discount is to be applied to a price for the produce item based on the difference.

In an embodiment, at 251, the produce freshness manager obtains the discount from a plurality of discounts based on the difference falling with a range of discounts. Each range of discount (discount amount) linked or mapped to a specific one of the plurality of discounts, and the discount is obtained based on the difference falling within one of the ranges that is linked to applied discount.

According to an embodiment, at 260, the produce freshness manager provides the discount to a transaction manager for processing a transaction for the produce item at a POS terminal.

In an embodiment, the produce freshness manager processes on a store server and is interfaced to cameras that are situated in a produce area of the store. The processing to detect the produce freshness is utilized to determine whether to discount the produce and/or whether the produce needs to be replaced because it is too rotten. The produce freshness manager can send messages to the appropriate systems to account for the discounted produce when the customer is actively scanning the produce while shopping within the store and to account for when alerts need to be raised to replace the any rotten produce.

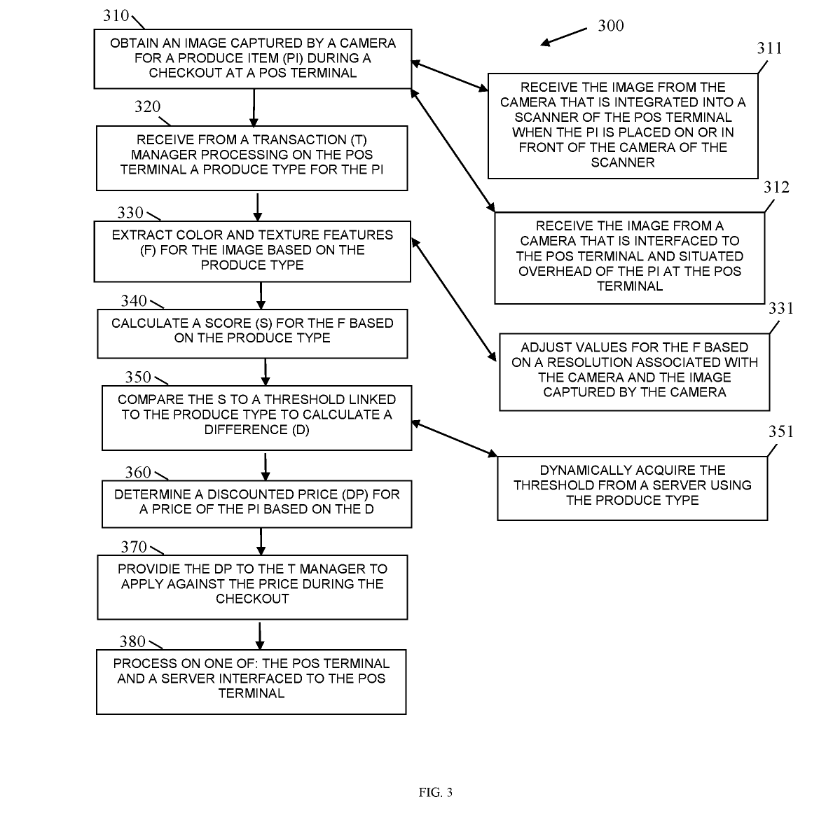

FIG. 3 is a diagram of another method 300 for image processing to detect aging produce, according to an example embodiment. The software module(s) that implements the method 300 is referred to as a “produce manager.” The produce manager is implemented as executable instructions programmed and residing within memory and/or a non-transitory computer-readable (processor-readable) storage medium and executed by one or more processors of a device. The processors that execute the produce manager are specifically configured and programmed to process the produce manager. The produce manager has access to one or more network connections during its processing. The network connections can be wired, wireless, or a combination of wired and wireless.

In an embodiment, the produce manager is the produce image processor 112 or the image processor 131.

In an embodiment, the produce manager is the method 200.

In an embodiment, the device that executes the produce manager is the POS terminal 110. In an embodiment, the POS terminal 110 is a SST. In an embodiment, the POS terminal 110 is a cashier-assisted checkout terminal.

The produce manager presents another and in some ways an enhanced processing perspective of the method 200.

At 310, the produce manager obtains an image captured by a camera for a produce item during a checkout at a POS Terminal.

In an embodiment, at 311, the produce manager receives the image from the camera that is integrated into a scanner of the POS terminal when the produce item is placed on or in front of the camera of the scanner.

In an embodiment, at 312, the produce manager receives the image from a camera that is interfaced to the POS terminal and situated overhead at the POS terminal.

At 320, the produce manager receives from a transaction manager processing on the POS terminal a produce type for the produce item.

At 330, the produce manager extracts color and texture features for the image based on the produce type.

In an embodiment, at 331, the produce manager adjusts the features based on a resolution associated with the camera and the image captured by the camera.

At 340, the produce manager calculates a score for the features based on the produce type.

At 350, the produce manager compares the score to a threshold linked to the produce type to calculate a difference.

In an embodiment, at 351, the produce manager dynamically acquires the threshold from a server interfaced to the POS terminal using the produce type.

At 360, the produce manager determines a discounted price for a price of the produce item based on the difference.

At 370, the produce manager provides the discounted price to the transaction manager for applying against the price during the checkout.

According to an embodiment, at 380, the produce manager is processed on one of: the POS terminal and a server interfaced to the POS terminal during the checkout.

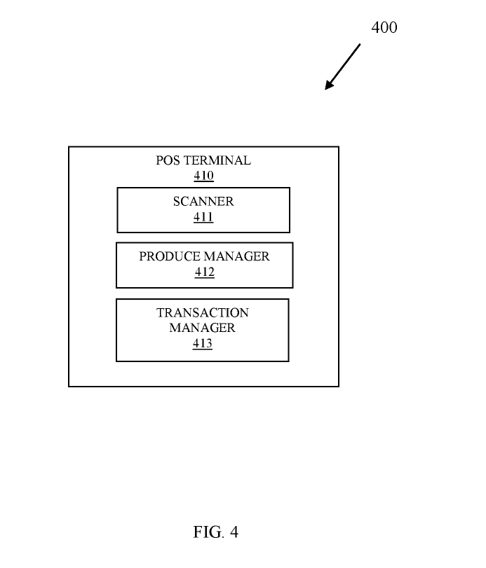

FIG. 4 is a diagram of a system 400 for image processing to detect aging produce, according to an example embodiment. The system 400 includes a variety of hardware components and software components. The software components of the system 400 are programmed and reside within the memory of a non-transitory computer-readable medium and executes on one or more processors of the system 400. The system 400 may communicate over one or more networks, which can be wired or wireless or, a combination of wired and wireless.

In an embodiment, the system 400 implements, inter alia, the processing discussed above with the FIGS. 1-3.

The system 400 includes a POS terminal 410 having a scanner 411, a produce manager 412, and a transaction manager 413.

In an embodiment, the POS terminal 410 is a SST. In an embodiment, the POS terminal 410 is a cashier-assisted checkout terminal.

In an embodiment, the scanner 411 is a combined scanner and produce weigh scale.

The scanner 411 is configured to capture an image of a produce item placed in the field-of-view of the scanner during a checkout at the POS terminal 410 and provide the image to the produce manager 412.

The transaction manager 413 is configured to provide a produce type for the produce item to the produce manager 412.

The produce manager 412 is configured to: extract image features for the image based on the produce type, calculate a score for the features based on the produce type, compare the score to a threshold linked to the produce type to calculate a difference, determine a discount to be apply to a price for the produce item based on the difference, and provide the discount to the transaction manager 413 for applying against the price during the checkout at the POS terminal 410.

The produce manager 412 and the transaction manager 413 both configured to execute on a least one hardware processor of the POS terminal 410. The scanner 411 interfaced to the POS terminal 410 through an interface connection, such as a Universal Serial Bus (USB) connection for providing the image of the produce item.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving an image for a produce item;
extracting features from the image;
scoring the features to calculate a score;
comparing the score against a threshold to calculate a difference; and
determining whether a discount is to be applied to a price of the produce item based on the difference.

2. The method of claim 1 further comprising, providing the discount to a transaction manager for processing a transaction for the produce item at a Point-Of-Sale (POS) terminal.

3. The method of claim 1, wherein receiving further includes obtaining the image from a scanner during a checkout for the produce item at a Point-Of-Sale (POS) terminal.

4. The method of claim 1, wherein receiving further includes obtaining the image from a camera interfaced to a Point-Of-Sale (POS) terminal during a checkout for the produce item at the POS terminal.

5. The method of claim 1, wherein extracting further includes extracting color pixel values from the image based on a type of produce for the produce item.

6. The method of claim 1, wherein extracting further includes calculating a texture or smoothness in transitions within pixel values for the image.

7. The method of claim 1, wherein scoring further includes processing a scoring algorithm based on a type of produce for the produce item.

8. The method of claim 1, wherein scoring further includes further includes counting a specific number of occurrences of a specific color that are present in the features.

9. The method of claim 1, wherein scoring further includes counting a specific number of textures representing wrinkling that are present in the features.

10. The method of claim 1, wherein comparing further includes obtaining the threshold from a plurality of thresholds based on a type of produce for the produce item.

11. The method of claim 10, wherein obtaining further includes acquiring the plurality of thresholds from a server, wherein each threshold linked to a specific type of produce.

12. The method of claim 1, wherein determining further includes obtaining the discount from a plurality of discounts based on the difference compared against a range of discounts, each range of discounts linked to a specific one of the plurality of discounts and the difference falls within one of the ranges.

13. A method, comprising:
obtaining an image captured by a camera for a produce item during a checkout at a Point-Of-Sale (POS) terminal;
receiving from a transaction manager processing on the POS terminal a produce type for the produce item;
extracting color and texture features for the image based on the produce type;
calculating a score for the features based on the produce type;
comparing the score to a threshold linked to the produce type to calculate a difference;
determining a discounted price for a price of the produce item based on the difference; and
providing the discounted price to the transaction manager to apply against the price during the checkout.

14. The method of claim 13, wherein obtaining further includes receiving the image from the camera that is integrated into a scanner of the POS terminal when the produce item is placed on or in front of the camera of the scanner.

15. The method of claim 13, wherein obtaining further includes receiving the image from a camera that is interfaced to the POS terminal and situated overhead of the produce item at the POS terminal.

16. The method of claim 13, wherein extracting further includes adjusting values for the features based on a resolution associated with the camera and the image captured by the camera.

17. The method of claim 13, wherein comparing further includes dynamically acquiring the threshold value from a server using the produce type.

18. The method of claim 13 further comprising, processing the method on one of: the POS terminal and a server interfaced to the POS terminal.

19. A system, comprising:
a Point-Of-Sale (POS) terminal;
the POS terminal including:
a scanner;
a produce manager; and
a transaction manager;
wherein the scanner is configured to capture an image of a produce item placed in the field-of-view of the scanner during a checkout at the POS terminal and provide the image to the produce manager, wherein the transaction manager is configured to provide a produce type for the produce item to the produce manager, and wherein the produce manager is configured to: extract image features for the image based on the produce type, calculate a score for the features based on the produce type, compare the score to a threshold linked to the produce type to calculate a difference, determine a discount to be apply to a price for the produce item based on the difference, and provide the discount to the transaction manager for applying against the price during the checkout.

20. The system of claim 19, wherein the POS terminal is one of: a Self-Service Terminal (SST) and a cashier-assisted checkout terminal.
